(19) United States
(12) Patent Application Publication
(10) Pub. No.: US 2025/0088245 A1
(43) Pub. Date: Mar. 13, 2025

(54) PHYSICAL LAYER SIGNALING PROCEDURES FOR AI/ML BASED CHANNEL FEEDBACK

(71) Applicant: Indian Institute of Technology Madras (IIT Madras), Chennai (IN)

(72) Inventors: Radhakrishna GANTI, Chennai (IN); Venkata Siva Sai Prasad PIRATI, Chennai (IN); Anil Kumar YERRAPRAGADA, Telangana (IN); Jeeva Keshav SATTIANARAYANIN, Puducherry (IN)

(21) Appl. No.: 18/799,434

(22) Filed: Aug. 9, 2024

(30) Foreign Application Priority Data
Aug. 11, 2023 (IN) 202341054172

(51) Int. Cl. H04B 7/06

(52) U.S. Cl. CPC H04B 7/0626; H04B 7/0632; H04B 7/0658

(57) ABSTRACT

The present invention describes a method of evaluating performance of a two-sided model used for performing CSI compression. The method includes receiving a first reference signal in a first time slot (t). A first channel Hₜ and a first Channel Quality Indicator (CQIₜ) are estimated at a first time instance. The first channel (Hₜ) is compressed using an encoder of a two-sided model. A compressed channel (Hₜ) along with the CQIₜ is transmitted to a Base Station (BS) (102). A second reference signal precoded with a reconstructed channel (Ĥₜ) is received in a second time slot (t+1). A second channel Hₜ₊₁ and a second CQIₜ₊₁ are estimated at a second time instance. The second CQI (CQIₜ₊₁) and the first CQI (CQIₜ) are compared for determining performance of the encoder of the two-sided model.

### FIELD OF INVENTION

The present invention generally relates to use of Artificial Intelligence/Machine Learning (AI/ML) techniques in telecommunication networks. In particular, the present invention relates to usage of AI/ML techniques for Channel State Information (CSI) compression.

### BACKGROUND OF THE INVENTION

In modern wireless communication systems multiple antennas i.e., Multiple Input Multiple Output (MIMO) antennas are used. It is assumed that the wireless communication leverages the MIMO antennas and involves modulation and channel coding based on standardized schemes. Without loss of generality, one example of a transmitter is a cellular base station (Network or NW) and one example of a receiver is a User Equipment (UE). In order for the transmitter to adjust certain transmission parameters, information about characteristics of the wireless medium is required. Such information, referred to as Channel State Information (CSI), helps the transmitter to adjust modulation scheme, channel coding, radio resource allocation etc., thus achieving better throughput.

To obtain the CSI, a transmitter sends reference signals to a receiver, the receiver estimates the channel and computes channel quality metrics, and the receiver feeds the channel along with the metrics back to the transmitter.

Contents of a channel state feedback could range from the complete channel estimates to merely the quality metrics such as Precoder Matrix Index (PMI), Channel Quality Indicator (CQI), Rank Indicator (RI), Layer Indicator (LI) etc. A popular method for increasing throughput between the transmitter and receiver includes using the PMI, which maps to a precoder matrix in a pre-defined codebook (collection of pre-defined matrices that are known to both transmitter and receiver). This precoder when applied to subsequent transmissions, mitigates the effects of multi-path channels and interference. The PMI can have different granularities for different types of codebooks i.e., the size of the codebook increases (and therefore the number of PMIs) as the granularity increases. Thus, there is a trade-off between channel feedback overhead and more granular (accurate) channel state information. Furthermore, the feedback information is directly proportional to the number of transmission ports/antennas that the transmitter has. Thus, in advanced wireless systems, where the number of antennas is of the order of tens or hundreds or higher, it is important to find solutions to compress the channel state feedback to minimize the overhead.

The codebook-based CSI feedback has certain limitations. Current state of the art codebooks (such as those used in 5G) exploit sparsity in the antenna domain and frequency domain to compress the channel matrix and/or its eigenvectors. However, the compression ratios as per the defined codebooks are limited. To achieve even better compression ratios, AI/ML based approaches are explored. Another motivating factor is the success of AI/ML in other domains such as image recognition and Natural Language Processing.

Typically, an AI/ML based architecture for CSI compression involves a two-sided model consisting of an encoder and a decoder. The encoder compresses information and the decoder reconstructs the information. In the transmitter-receiver notion described above, the receiver uses the encoder to compress the true CSI (estimated channel) and the transmitter uses the decoder to reconstruct the compressed CSI. The two-sided model has two parts that can be deployed at two physically different locations (such as transmitter and receiver). These two parts could be trained either jointly or separately. Irrespective of the training mechanism, both parts of the model are required to operate together during inference. In other words, the input to the encoder of the two-sided model, such as CSI, could be measured at the receiver (for example, at UE) and the reconstruction of the CSI is done at the transmitter (for example, a base station). One essential component of the life cycle of AI/ML models is periodic performance monitoring. In order to monitor the performance of the two-sided model, both input (ground truth CSI) and output (reconstructed CSI) are needed at one location. One way to fulfil such requirement includes (a) transferring the ground truth CSI to a location where the decoder is located (for example, the base station) or (b) transferring the reconstructed CSI to the location where the encoder is located (for example, the UE). Both of these approaches involve transmission of large overheads which consumes a large amount of bandwidth.

Therefore, there exists a need of an efficient mechanism using which the performance of the two-sided AI/ML models could be evaluated by consuming least amount of bandwidth.

### OBJECTS OF THE INVENTION

An object of the invention is to provide a method of determining performance of an Artificial Intelligence/Machine Learning (AI/ML) model used for performing Channel State Information (CSI) compression in a wireless communication network.

Another object of the invention is to provide a method of determining performance of the AI/ML model using Channel Quality Indicator (CQI).

### SUMMARY OF THE INVENTION

The summary is provided to introduce aspects related to a method of determining performance of an Artificial Intelligence/Machine Learning (AI/ML) model used for performing Channel State Information (CSI) compression. This summary is not intended to identify essential features of the claimed subject matter nor is it intended for use in determining or limiting the scope of the claimed subject matter.

In a preferred embodiment, the present invention describes a method to be performed by a UE. The method comprises receiving a first reference signal in a first time slot (t). The method further comprises estimating a first channel Hₜ and a first Channel Quality Indicator (CQIₜ) at a first time instance. The method further comprises compressing the first channel (Hₜ) using an encoder of a two-sided model for Channel State Information (CSI) compression. The method further comprises transmitting a compressed channel (Hₜ) along with the CQIₜ to a Base Station (BS). The method further comprises receiving a second reference signal precoded with a reconstructed channel (Ĥₜ) in a second time slot (t+1). The reconstructed channel (Ĥₜ) is generated from the compressed channel (Hₜ) by a decoder of the two-sided model of the BS. The method further comprises estimating a second channel Hₜ₊₁ and a second CQIₜ₊₁ at a second time instance. The method further comprises comparing the second CQI (CQIₜ₊₁) and the first CQI (CQIₜ) for determining performance of the encoder of the two-sided model. The comparison could be done at both ends i.e. the UE and the BS/NW. For comparison at the NW, the second CQI (CQIₜ₊₁) is transmitted from the UE to the NW.

In one aspect, the UE receives a ground-truth CSI report in a periodic, aperiodic, or semi-persistent manner.

In a preferred embodiment, the present invention describes a UE comprising a processor and a memory coupled to the processor. The memory comprises programmed instructions to receive a first reference signal in a first time slot (t). The memory further comprises programmed instructions to estimate a first channel Hₜ and a first Channel Quality Indicator (CQIₜ) at a first time instance. The memory further comprises programmed instructions to compress the first channel (Hₜ) using an encoder of a two-sided model for CSI compression. The memory further comprises programmed instructions to transmit a compressed channel (Hₜ) along with the CQIₜ to a Base Station (BS). The memory further comprises programmed instructions to receive a second reference signal precoded with a reconstructed channel (Ĥₜ) in a second time slot (t+1). The reconstructed channel (Ĥₜ) is generated from the compressed channel (Hₜ) by a decoder of the two-sided model of the BS. The memory further comprises programmed instructions to estimate a second channel Hₜ₊₁ and a second CQIₜ₊₁ at a second time instance. The memory further comprises programmed instructions to compare the second CQI (CQIₜ₊₁) and the first CQI (CQIₜ) for determining performance of the encoder of the two-sided model.

In one aspect, the UE is further configured to receive, from the BS, a ground-truth CSI report in a periodic, aperiodic, or semi-persistent manner.

In one embodiment, the present invention describes a BS comprising a processor and a memory coupled to the processor. The memory comprises programmed instructions to estimate a first channel Hₜ and a first Channel Quality Indicator (CQIₜ) at a first time instance. The memory further comprises programmed instructions to receive, from a UE, a second CQI (CQIₜ₊₁) estimated by the UE. The memory further comprises programmed instructions to compare the second CQI (CQIₜ₊₁) and the first CQI (CQIₜ) for determining performance of an encoder of a two-sided model for CSI compression.

Other aspects and advantages of the invention will become apparent from the following description, taken in conjunction with the accompanying drawings, illustrating by way of example the principles of the invention.

### BRIEF DESCRIPTION OF THE DRAWINGS

The accompanying drawings constitute a part of the description and are used to provide further understanding of the present invention. Such accompanying drawings illustrate the embodiments of the present invention which are used to describe the principles of the present invention. The embodiments are illustrated by way of example and not by way of limitation in the figures of the accompanying drawings in which like references indicate similar elements. It should be noted that references to “an” or “one” embodiment in this invention are not necessarily made to the same embodiment, and they mean at least one. In the accompanying drawings:

FIG. 1 illustrates a network diagram showing communication between a network/Base Station and a User Equipment (UE) for evaluating performance of a two-sided AI/ML model, in accordance with an embodiment of the present invention; and

FIG. 2 illustrates a timing diagram of communication occurring between a network/Base Station and a UE for evaluating performance of a two-sided AI/ML model, in accordance with an embodiment of the present invention.

A more complete understanding of the present invention and its embodiments thereof may be acquired by referring to the following description and the accompanying drawings.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

Approximating language, as used herein throughout the specification and claims, may be applied to modify any quantitative representation that could permissibly vary without resulting in a change in the basic function to which it is related. Accordingly, a value modified by a term or terms, such as “less than,” “approximately” etc. is not limited to the precise value specified. In some instances, the approximating language may correspond to the precision of an instrument for measuring the value.

The present invention describes several aspects of using Artificial Intelligence/Machine Learning (AI/ML) for Channel State Information (CSI) feedback enhancement. Specifically, protocol and signalling implications of deploying AI/ML based CSI compression are described. Further, procedures for monitoring model performance are also described.

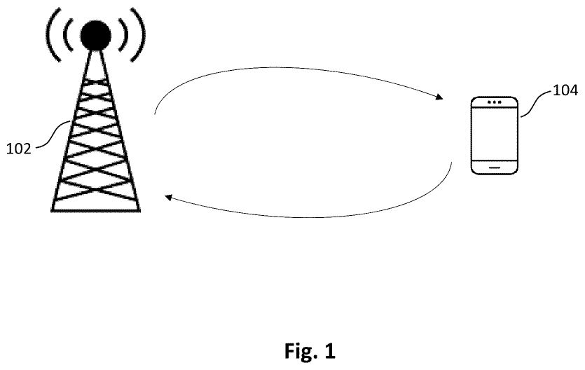

FIG. 1 illustrates a network diagram showing communication between a Network/Base Station 102 and a User Equipment (UE) 104 for evaluating performance of a two-sided AI/ML model, in accordance with an embodiment of the present invention.

In one implementation, SINR-based signaling may be performed between the UE 104 and the network 102. Such SINR-based signaling may include performing the below mentioned steps.
a. A UE-side model encodes CSI and a network-side model reconstructs CSI,
b. The network transmits precoded CSI-RS to the UE 104,
c. The UE 104 measures Signal-to-Interference-plus-Noise Ratio (SINR) and returns Channel Quality Indicator (CQI) to the network 102, and
d. Variation in CQI in a current slot is compared with prior slots to point towards reconstruction error. With these steps, performance of the AI/ML model is evaluated.

In another implementation, Ground truth CSI verification may be performed between the UE 104 and the network 102. Such method includes the below mentioned steps.
a. The network 102 transmits CSI-RS to the UE 104,
b. The UE 104 estimates the channel and the UE-side model encodes CSI,
c. The network 102 obtains ground truth information from the UE 104, and
d. The network-side model reconstructs CSI and compares reconstructed CSI with ground truth. With these steps, performance of the AI/ML model is evaluated.

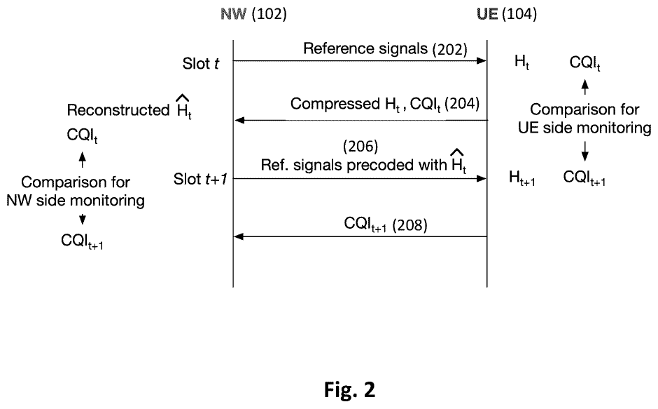

FIG. 2 illustrates a timing diagram of communication occurring between the network 102 and the UE 104 for evaluating performance of a two-sided AI/ML model for Channel State Information (CSI) compression, in accordance with an embodiment of the present invention. At step 202, the network 102 transmits reference signals in a time slot t. The UE 104 estimates a channel Hₜ and a Channel Quality Indicator, CQIₜ. At step 204, the UE 104 compresses the channel Hₜ using an encoder of the two-sided model and transmits compressed channel along with CQIₜ to the network 102. The network 102 obtains a reconstructed channel Ĥₜ by executing a decoder of the two-sided model on the compressed channel. At step 206, the network 102 transmits reference signals in a time slot t+1 precoded with the reconstructed channel Ĥₜ. The UE 104 estimates the channel Hₜ₊₁ and CQIₜ₊₁. At step 208, the UE 104 sends the CQIₜ₊₁ to the network 102. Thereafter, evaluation of the AI/ML model at the network 102 and the UE 104 can be done by comparing CQIₜ₊₁ and CQIₜ. In this manner, performance of the two-sided AI/ML models used for CSI compression can be performed using communication of least amount of overheads.

Additionally, the UE 104 may also transmit the second CQI (CQIₜ₊₁) to the network 102. The network 102 may compare the second CQI (CQIₜ₊₁) and the first CQI (CQIₜ) for determining performance of the encoder of the two-sided model. In the above described manner, the network 102 and the UE 104, both can determine performance of the two-sided model used for CSI compression.

The terms “or” and “and/or” as used herein are to be interpreted as inclusive or meaning any one or any combination. Therefore, “A, B or C” or “A, B and/or C” may mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method, comprising:
receiving, by a UE (104), a first reference signal in a first time slot (t);
estimating, by the UE (104), a first channel Hₜ and a first Channel Quality Indicator (CQIₜ) at a first time instance;
compressing, by the UE (104), the first channel (Hₜ) using an encoder of a two-sided model for Channel State Information (CSI) compression;
transmitting, by the UE (104), a compressed channel (Hₜ) along with the first CQIₜ to a Base Station (BS) (102);
receiving, by the UE (104), a second reference signal precoded with a reconstructed channel (Ĥₜ) in a second time slot (t+1), wherein the reconstructed channel (Ĥₜ) is generated from the compressed channel (Hₜ) by a decoder of the two-sided model of the BS (102);
estimating, by the UE (104), a second channel Hₜ₊₁ and a second CQIₜ₊₁ at a second time instance; and
comparing, by the UE (104), the second CQI (CQIₜ₊₁) and the first CQI (CQIₜ) for determining performance of the encoder of the two-sided model.

2. The method as claimed in claim 1, further comprising transmitting the second CQI (CQIₜ₊₁) to the BS (102), wherein the BS (102) compares the second CQI (CQIₜ₊₁) and the first CQI (CQIₜ) for determining the performance of the encoder of the two-sided model.

3. The method as claimed in claim 1, further comprising receiving, from the BS (102), by the UE (104), a ground-truth CSI report in a periodic, aperiodic, or semi-persistent manner.

4. A UE (104) comprising:
a processor; and
a memory coupled to the processor, wherein the memory comprises programmed instructions to:
receive a first reference signal in a first time slot (t);
estimate a first channel Hₜ and a first Channel Quality Indicator (CQIₜ) at a first time instance;
compress the first channel (Hₜ) using an encoder of a two-sided model for CSI compression;
transmit a compressed channel (Hₜ) along with the CQIₜ to a Base Station (BS) (102);
receive a second reference signal precoded with a reconstructed channel (Ĥₜ) in a second time slot (t+1), wherein the reconstructed channel (Ĥₜ) is generated from the compressed channel (Hₜ) by a decoder of the two-sided model of the BS (102);
estimate a second channel Hₜ₊₁ and a second CQIₜ₊₁ at a second time instance; and
compare the second CQI (CQIₜ₊₁) and the first CQI (CQIₜ) for determining performance of the encoder of the two-sided model.

5. A BS (102) comprising:
a processor; and
a memory coupled to the processor, wherein the memory comprises programmed instructions to:
estimate a first channel Hₜ and a first Channel Quality Indicator (CQIₜ) at a first time instance;
receive, from a UE (104), a second CQI (CQIₜ₊₁) estimated by the UE (104); and
compare the second CQI (CQIₜ₊₁) and the first CQI (CQIₜ) for determining performance of an encoder of a two-sided model for CSI compression.
